(19) United States
(12) Patent Application Publication
(10) Pub. No.: US 2011/0286557 A1
(43) Pub. Date: Nov. 24, 2011

(54) RECEIVING APPARATUS

(75) Inventor: Motohiko Hayashi, Kanagawa (JP)

(73) Assignee: KABUSHIKI KAISHA TOSHIBA, Tokyo (JP)

(21) Appl. No.: 13/042,612

(22) Filed: Mar. 8, 2011

(30) Foreign Application Priority Data
May 19, 2010 (JP) 2010-115292

(51) Int. Cl. H04L 27/08

(52) U.S. Cl. 375/345

(57) ABSTRACT

According to one embodiment, a variable gain amplifier amplifies a reception signal, a mixer performs frequency conversion of the reception signal amplified by the variable gain amplifier, a detector detects the reception signal subjected to the frequency conversion, an automatic gain control unit controls, based on a detection level by the detector, a gain of the variable gain amplifier, and an operating-point optimizing unit optimizes an operating point of the variable gain amplifier by controlling, based on a reception state of the reception signal, an output signal from the mixer.

### CROSS-REFERENCE TO RELATED APPLICATIONS

This application is based upon and claims the benefit of priority from the prior Japanese Patent Application No. 2010-115292, filed on May 19, 2010; the entire contents of which are incorporated herein by reference.

### FIELD

Embodiments described herein relate generally to a receiving apparatus.

### BACKGROUND

In a receiving apparatus in the past, to prevent an operating point of a variable gain amplifier from shifting from an optimum position because of a disturbing wave, an input of a detector, which controls a gain of the variable gain amplifier, is fixed in a sufficiently wide band such that the detector can detect the disturbing wave.

When the disturbing wave is larger than a desired wave, the disturbing wave is detected to control the gain of the variable gain amplifier. At this point, a state of unnecessary components (noise) of the receiving apparatus depends on a sum of a noise figure (NF) of the receiving apparatus and a distortion caused by the disturbing wave and changes according to fluctuation in the operating point of the variable gain amplifier. Therefore, when the disturbing wave is fixed at a certain signal level and a certain detuning frequency with respect to the desired wave, there is an optimum operating point of the variable gain amplifier at which a sum of the unnecessary components is minimized.

In an IF detection system AGC circuit, to detect an IF level of a mixer output, there is also a method of providing a variable low-pass filter before a detector separately from a low-pass filter, specifying, according to a channel of a digital television, a channel of an analog television that causes a disrobing wave, setting a cutoff frequency of the variable low-pass filter such that the detector can detect a level of a disturbing analog television signal of the channel, and controlling the cutoff frequency of the variable low-pass filter to suppress a signal output by a mixer, which is an unnecessary signal undesirable to be input to the detector.

However, if the input of the detector is fixed in a sufficiently wide band such that the detector can detect the disturbing wave, even when the signal level and the detuning frequency of the disturbing wave with respect to the desired wave change, disturbing waves having different signal levels and different detuning frequencies are equally detected. Therefore, the operating point of the variable gain amplifier cannot be optimized with respect to the disturbing waves having the different signal levels and the detuning frequencies.

In the method of controlling the cutoff frequency of the variable low-pass filter to suppress the influence of the distortion due to the disturbing wave, it is necessary to specify, according to the channel of the digital television, the channel of the analog television that causes the disturbing wave. Disturbing waves in channels other than the specified channel cannot be suppressed.

### BRIEF DESCRIPTION OF THE DRAWINGS

FIG. 1 is a block diagram of a schematic configuration of a receiving apparatus according to a first embodiment of the present invention;

FIGS. 2A and 2B are diagrams for explaining the influence of the disturbing wave on a desired wave at the time when a detuning frequency of a disturbing wave having a certain signal level is different;

FIG. 3 is a diagram for explaining a method of setting an operating point of a variable gain amplifier shown in FIG. 1;

FIG. 4 is a diagram for explaining a method of changing a mixer output band shown in FIG. 1;

FIG. 5 is a block diagram of a schematic configuration of a receiving apparatus according to a second embodiment of the present invention;

FIG. 6 is a block diagram of a schematic configuration of a receiving apparatus according to a third embodiment of the present invention;

FIG. 7 is a flowchart for explaining a method of controlling a mixer output band by an adaptive control unit shown in FIG. 6;

FIG. 8 is a diagram of an image of a MER value and a decision bit in the flowchart of FIG. 7;

FIG. 9 is a block diagram of a schematic configuration of a receiving apparatus according to a fourth embodiment of the present invention;

FIG. 10 is a block diagram of a schematic configuration of a receiving apparatus according to a fifth embodiment of the present invention; and

FIG. 11 is a block diagram of a schematic configuration of a receiving apparatus according to a sixth embodiment of the present invention.

### DETAILED DESCRIPTION

In general, according to one embodiment, a receiving apparatus includes a variable gain amplifier, a mixer, a detector, an automatic gain control unit, and an operating-point optimizing unit. The variable gain amplifier amplifies a reception signal. The mixer performs frequency conversion of the reception signal amplified by the variable gain amplifier. The detector detects the reception signal subjected to the frequency conversion. The automatic gain control unit controls, based on a detection level by the detector, a gain of the variable gain amplifier. The operating-point optimizing unit optimizes an operating point of the variable gain amplifier by controlling, based on a reception state of the reception signal, an output signal from the mixer.

Exemplary embodiments of a receiving apparatus will be explained below in detail with reference to the accompanying drawings. The present invention is not limited to the following embodiments.

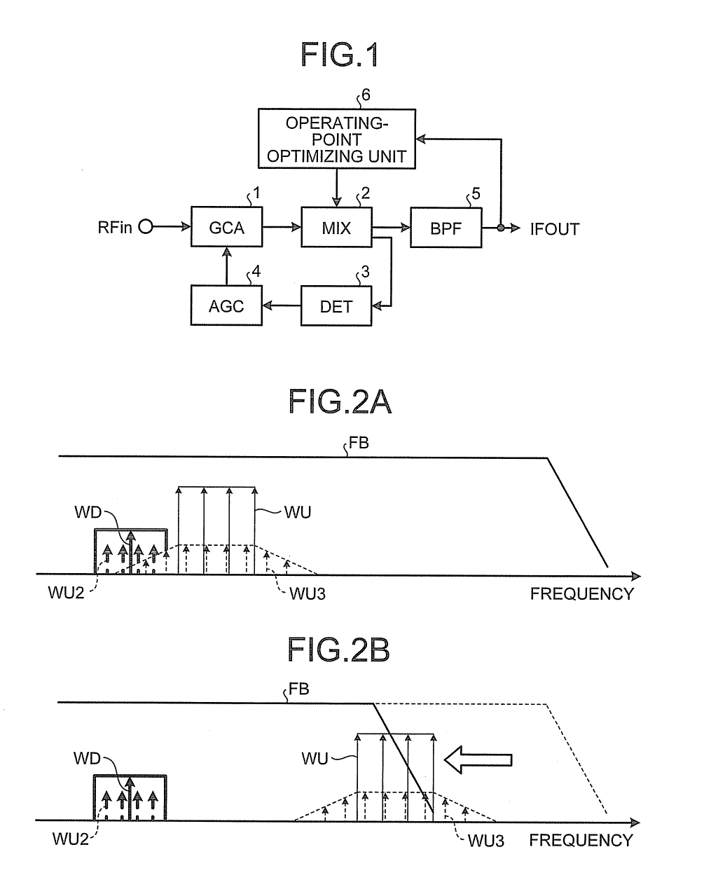

FIG. 1 is a block diagram of a schematic configuration of a receiving apparatus according to a first embodiment of the present invention. The receiving apparatus can be used for a digital television tuner for mobile communication.

In FIG. 1, the receiving apparatus includes a variable gain amplifier 1, a mixer 2, a detector 3, an automatic gain control unit 4, a band pass filter 5, and an operating-point optimizing unit 6. The operating-point optimizing unit 6 can optimize an operating point of the variable gain amplifier 1 by controlling, based on a reception state of a reception signal RFin, an output signal from the mixer 2.

After being amplified by the variable gain amplifier 1, the reception signal RFin in a radio frequency band is converted into an intermediate frequency band or a base band frequency band by the mixer 2. Unnecessary components are attenuated by the band pass filter 5. Consequently, an output signal IFOUT is output.

The operating-point optimizing unit 6 determines, based on the output signal IFOUT, the reception state of the reception signal RFin. The operating-point optimizing unit 6 optimizes the operating point of the variable gain amplifier 1 by controlling, based on the reception state of the reception signal RFin, the output signal from the mixer 2.

As a method of determining the reception state of the reception signal RFin, for example, a modulation error ratio (MER) can be used. Alternatively, a detection level by the detector 3 can be used.

As a method of optimizing the operating point of the variable gain amplifier 1, for example, a band of a disturbing wave component included in the reception signal RFin can be controlled or a level of the output signal from the mixer 2 can be controlled.

The detector 3 detects the reception signal RFin subjected to the frequency conversion by the mixer 2 and outputs a detection level to the automatic gain control unit 4. The automatic gain control unit 4 controls, based on the detection level, a gain of the variable gain amplifier 1 to thereby control the output level from the mixer 2 to be fixed.

Because the output signal from the mixer 2 is controlled based on the reception state of the reception signal RFin, even when a signal level and a detuning frequency of a disturbing wave included in the reception signal RFin change, it is possible to optimize the operating point of the variable gain amplifier 1 and reduce unnecessary components that depend on a sum of a noise figure (NF) of the receiving apparatus and a distortion caused by the disturbing wave.

FIGS. 2A and 2B are diagrams for explaining the influence of the disturbing wave on a desired wave at the time when a detuning frequency of a disturbing wave having a certain signal level is different.

In FIGS. 2A and 2B, a secondary distortion WU2 of a disturbing wave WU occurs in a band near a desired wave WD. A tertiary distortion WU3 of the disturbing wave WU occurs in a band near the disturbing wave WU. Therefore, as shown in FIG. 2A, when the disturbing wave WU detunes about several tens megahertz with respect to the desired wave WD, the influence of near disturbance by the tertiary distortion WU3 increases. As shown in FIG. 2B, when the disturbing wave WU detunes about several tens megahertz to 300 megahertz with respect to the desired wave WD, the influence of far disturbance by the secondary distortion WU2 increases.

On the other hand, the sensitivity of the receiving apparatus depends on an SN ratio (S is a signal component and N is a sum of unnecessary'components). When there is the disturbing wave WU, the sum of unnecessary components N depends on a sum of noise (NF) of the receiving apparatus itself, the secondary distortion WU2 of the disturbing wave WU, and the tertiary distortion WU3 of the disturbing wave WU. Therefore, the sum of unnecessary components N fluctuates according to a signal level and a detuning frequency of the disturbing wave WU with respect to the desired wave WD and an optimum operating point of the variable gain amplifier 1 also fluctuates. Therefore, to optimize the operating point of the variable gain amplifier 1, it is necessary to change the operating point of the variable gain amplifier 1 according to the signal level and the detuning frequency of the disturbing wave WU with respect to the desired wave WD.

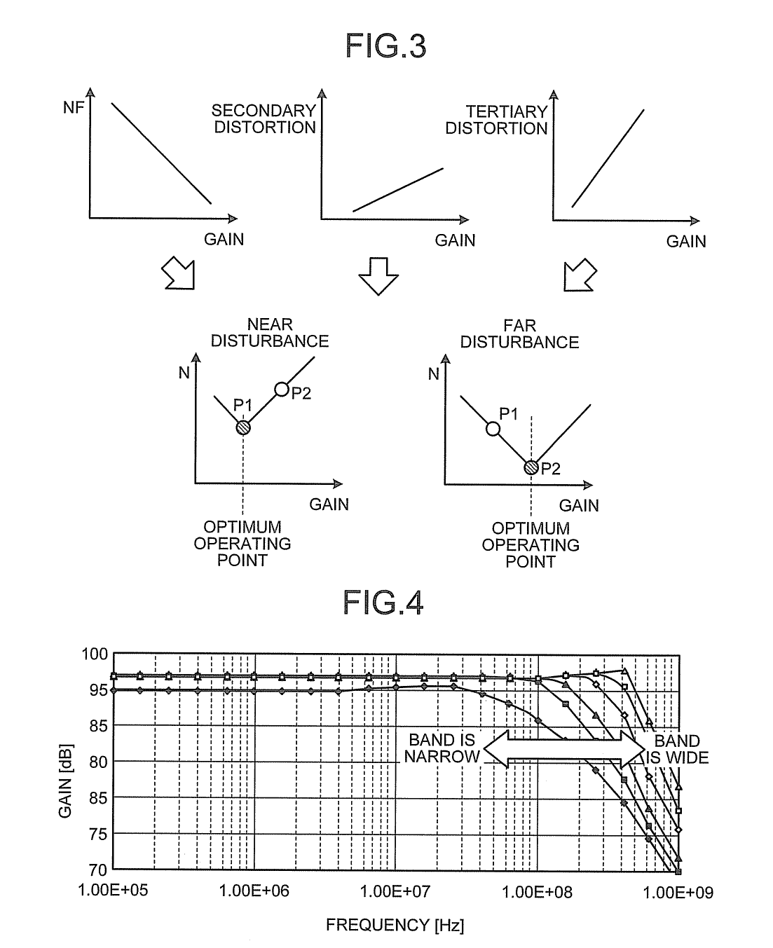

FIG. 3 is a diagram for explaining a method of setting the operating point of the variable gain amplifier shown in FIG. 1.

In FIG. 3, when the gain of the variable gain amplifier 1 rises, the noise (NF) of the receiving apparatus itself decreases and the secondary distortion WU2 and the tertiary distortion WU3 of the disturbing wave WU increase. Therefore, the sum of unnecessary components N increases irrespective of whether the gain of the variable gain amplifier 1 excessively rises or excessively falls. An optimum operating point at which the sum of unnecessary components N is minimized is present.

It is assumed that an output band FB of the mixer 2 is fixed in a sufficiently wide band such that all disturbing waves WU can be detected irrespective of a signal level and a detuning frequency. Then, when the influence of near disturbance shown in FIG. 2A is strong, to secure the sensitivity of the receiving apparatus, it is necessary to set the operating point of the variable gain amplifier 1 such that the influence of the tertiary distortion WU3 decreases. Therefore, the operating point of the variable gain amplifier 1 is set at P1 shown in FIG. 3.

When the operating point of the variable gain amplifier 1 is set at P1, if the influence of the far disturbance shown in FIG. 2B is strong, the influence of an increase in the noise (NF) of the receiving apparatus itself increases all the more. The sum of unnecessary components N increases compared with when the operating point of the variable gain amplifier 1 is set at P2.

On the other hand, when the output band FB of the mixer 2 is changed and the influence of the far disturbance shown in FIG. 2B is strong, it is possible to reduce disturbing wave components included in the output signal of the mixer 2 by limiting the output band FB of the mixer 2 to cover the disturbing wave WU. When the disturbing wave components included in the output signal of the mixer 2 decrease, the detection level by the detector 3 falls. Therefore, the automatic gain control unit 4 controls the gain of the variable gain amplifier 1 to rise.

When the gain of the variable gain amplifier 1 is controlled to rise, the operating point of the variable gain amplifier 1 moves from P1 to P2. The operating point of the variable gain amplifier 1 is optimized such that the sum of unnecessary components N is minimized.

FIG. 4 is a diagram for explaining a method of changing a mixer output band shown in FIG. 1.

In FIG. 4, the output band FB of the mixer 2 is changed based on the reception state of the reception signal RFin. Consequently, the operating point of the variable gain amplifier 1 is optimized.

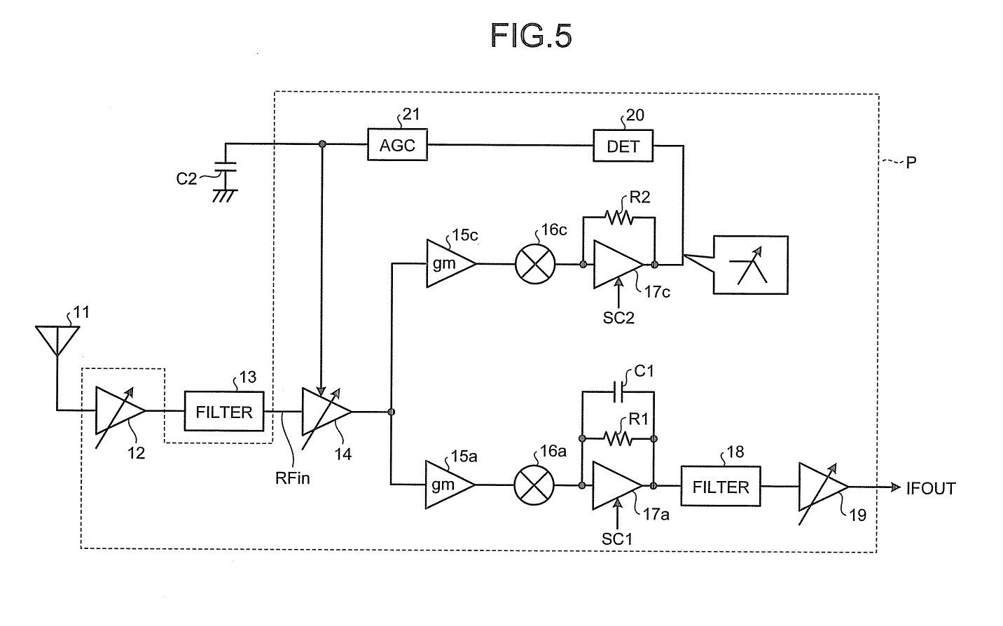

FIG. 5 is a block diagram of a schematic configuration of a receiving apparatus according to a second embodiment of the present invention.

In FIG. 5, the receiving apparatus includes a reception antenna 11, a low-noise amplifier 12, filters 13 and 18, variable gain amplifiers 14 and 19, voltage/current converters 15a and 15c, mixers 16a and 16c, operational amplifiers 17a and 17c, a detector 20, and an automatic gain control unit 21.

An output side of the automatic gain control unit 21 is grounded via a capacitor C2. A parallel circuit of a resistor R1 and the capacitor C1 is connected between input and output terminals of the operational amplifier 17a to form a low-pass filter. A resistor R2 is connected between input and output terminals of the operational amplifier 17c. A low-pass filter by a cutoff frequency of the operational amplifier 17c is formed.

The low-noise amplifier 12, the variable gain amplifiers 14 and 19, the voltage/current converters 15a and 15c, the mixers 16a and 16c, the operational amplifiers 17a and 17c, the filter 18, the detector 20, and the automatic gain control unit 21 can be integrated on a semiconductor chip P. In general, because the capacitor C2 and the filter 13 are large, for cost and universality, the capacitor C2 and the filter 13 are externally attached. However, the capacitor C2 and the filter 13 can also be integrated on the semiconductor chip P.

A desired wave is received by the reception antenna 11 together with a disturbing wave. After being amplified by the low-noise amplifier 12, the desired wave is sent to the variable gain amplifier 14 via the filter 13. After being amplified by the variable gain amplifier 14, the reception signal RFin is converted into electric currents by the voltage/current converters 15a and 15c and separately subjected to frequency conversion by the mixers 16a and 16c.

The reception signal RFin subjected to the frequency conversion by the mixer 16a passes through the operational amplifier 17a to have high-frequency components thereof attenuated. Then, a desired component is selected by the filter 18 and amplified by the variable gain amplifier 19. Consequently, the output signal IFOUT is output.

On the other hand, the reception signal RFin subjected to the frequency conversion by the mixer 16c passes through the operational amplifier 17c to have high-frequency components thereof attenuated by a cutoff frequency of the operational amplifier 17c. Then, the reception signal RFin is detected by the detector 20 and a detection level thereof is output to the automatic gain control unit 21. In the automatic gain control unit 21, a gain of the variable gain amplifier 14 is controlled based on the detection level, whereby an output level from the mixers 16a and 16c is controlled to be fixed.

A control signal SC1 for controlling a bias current of the operational amplifier 17a is input to the operational amplifier 17a. The bias current of the operational amplifier 17a is controlled based on a reception state of the reception signal RFin. Consequently, a distortion characteristic and the like are optimized. When a satisfactory distortion characteristic is not requested, for example, when there is no disturbing wave, the bias current is constricted and current consumption is reduced.

A control signal SC2 for controlling a bias current of the operational amplifier 17c is input to the operational amplifier 17c. The bias current of the operational amplifier 17c is controlled based on the reception state of the reception signal RFin. Consequently, a band of the low-pass filter formed by the operational amplifier 17c is controlled and an operating point of the variable gain amplifier 14 is optimized. As shown in FIG. 4, the cutoff frequency rises when the bias current of the operational amplifier 17c increases. Therefore, the band of the low-pass filter formed by the operational amplifier 17c expands. Conversely, the cutoff frequency falls when the bias current of the operational amplifier 17c decreases. Therefore, the band of the low-pass filter formed by the operational amplifier 17c narrows.

Consequently, even when the signal level and the detuning frequency of the disturbing wave included in the reception signal RFin change, it is possible to optimize the operating point of the variable gain amplifier 1. It is possible to reduce, while realizing low power consumption, the unnecessary components that depend on the sum of the noise figure (NF) of the receiving apparatus and the distortion caused by the disturbing wave.

An output path and a path for detection control are separately provided like the mixer 16a on the output signal IFOUT side and the mixer 16c on the detector 20 side. This makes it possible to prevent load fluctuation, which is caused when a signal input to the detector 20 is controlled, from affecting the output signal IFOUT.

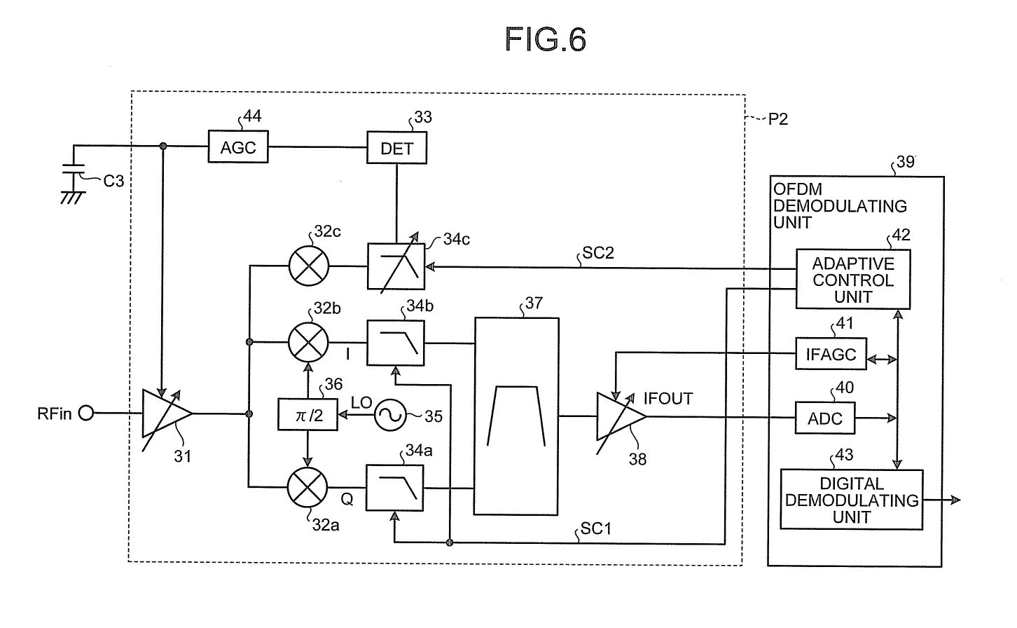

FIG. 6 is a block diagram of a schematic configuration of a receiving apparatus according to a third embodiment of the present invention.

In FIG. 6, the receiving apparatus includes variable gain amplifiers 31 and 38, mixers 32a to 32c, a detector 33, low-pass filters 34a and 34b, a variable band low-pass filter 34c, an oscillator 35, a phase shifter 36, an image rejection filter 37, an orthogonal frequency-division multiplexing (OFDM) demodulating unit 39, and an automatic gain control unit 44. An output side of the automatic gain control unit 44 is grounded via a capacitor C3.

The OFDM demodulating unit 39 includes an analog/digital (A/D) converter 40, an automatic gain control unit 41, an adaptive control unit 42, and a digital demodulating unit 43. The adaptive control unit 42 can generate, based on a reception state of the reception signal RFin, the control signal SC1 for controlling characteristics of the low-pass filters 34a and 34b and the control signal SC2 for controlling a band of the variable band low-pass filter 34c. The adaptive control unit 42 can use an MER or an SN as an index for determining the reception state of the reception signal RFin.

The variable gain amplifiers 31 and 38, the mixers 32a to 32c, the detector 33, the low-pass filers 34a and 34b, the variable band low-pass filter 34c, the oscillator 35, the phase shifter 36, the image rejection filter 37, and the automatic gain control unit 44 can be integrated on a semiconductor chip P2. In general, because the capacitor C2 is large, the capacitor C2 is externally attached. However, the capacitor C2 can also be integrated on the semiconductor chip P2. The OFDM demodulating unit 39 can be integrated on the semiconductor chip P2 or can be externally attached.

After being amplified by the variable gain amplifier 31, the reception signal RFin is output to the mixers 32a to 32c. A local oscillation signal LO generated by the oscillator 35 is phase-shifted 90° by the phase shifter 36. The local oscillation signal LO before the phase shift and the local oscillation signal LO after the phase shift are respectively output to the mixers 32a and 32b.

The reception signal RFin amplified by the variable gain amplifier 31 is mixed with the local oscillation signals LO before and after the phase shift by the mixers 32a and 32b. Consequently, an in-phase component I and an orthogonal component Q subjected to frequency conversion are generated and respectively output to the low-pass filters 34a and 34b.

After high-frequency components are attenuated by the low-pass filters 34a and 34b, a desired component is selected by the image rejection filter 37 and amplified by the variable gain amplifier 38. Consequently, the output signal IFOUT is output to the OFDM demodulating unit 39.

In the OFDM demodulating unit 39, after being digitized by the A/D converter 40, the output signal IFOUT is subjected to demodulation processing by the digital demodulating unit 43. A gain of the variable gain amplifier 38 is controlled by the automatic gain control unit 41 based on the digitized output signal IFOUT. The control signals SC1 and SC2 are generated by the adaptive control unit 42 based on the digitized output signal IFOUT. The control signal SC1 is output to the low-pass filters 34a and 34b. The control signal SC2 is output to the variable band low-pass filter 34c. A pass band is set by the variable band low-pass filter 34c such that an operating point of the variable gain amplifier 31 is optimized. Consequently, a sum of unnecessary components included in outputs of the mixers 32a and 32b is minimized. The unnecessary components can include noise of the receiving apparatus itself, a secondary distortion of a disturbing wave, and a tertiary distortion of the disturbing wave.

The reception signal RFin amplified by the variable gain amplifier 31 is subjected to frequency conversion by the mixer 32c and output to the variable band low-pass filter 34c. After high-frequency components of the reception signal RFin are attenuated by the variable band low-pass filter 34c, the reception signal RFin is detected by the detector 33 and a detection level thereof is output to the automatic gain control unit 44. A gain of the variable gain amplifier 31 is controlled by the automatic gain control unit 44 based on the detection level, whereby an output level from the mixers 32a and 32b is controlled to be fixed.

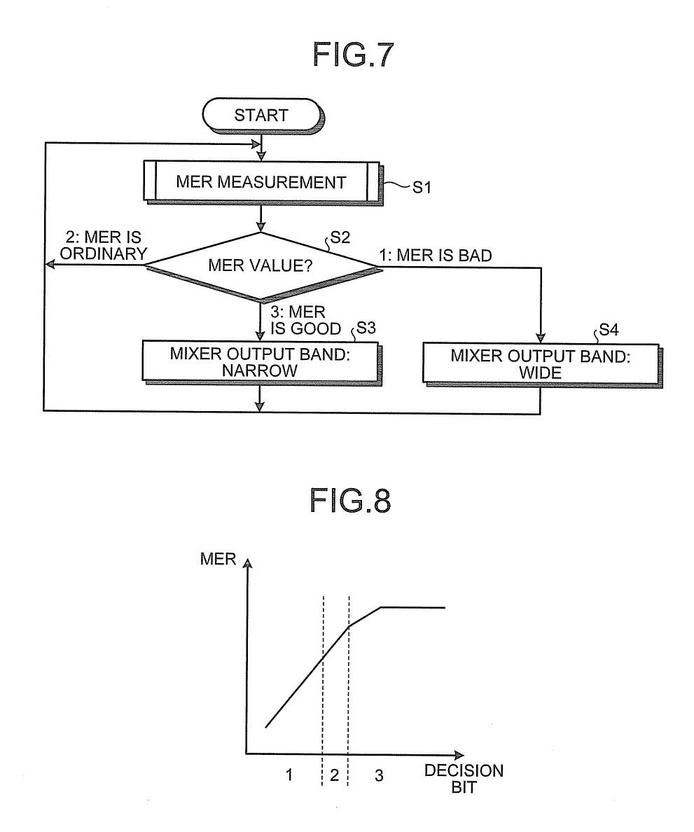

FIG. 7 is an example of a flowchart for explaining a method of controlling a mixer output band by the adaptive control unit shown in FIG. 6.

In FIG. 7, the adaptive control unit measures an MER starting from a narrower initial value of the mixer output band (step S1). When the MEER is ordinary (step S2), the adaptive control unit returns to step S1 and repeats the measurement of the MER. On the other hand, when the MER is good, the adaptive control unit narrows the band of the variable band low-pass filter 34c using the control signal SC2 to thereby narrow an output band of the mixer 32c (step S3). On the other hand, when the MER is bad, the adaptive control unit expands the band of the variable band low-pass filter 34c using the control signal SC2 to thereby expand the output band of the mixer 32c (step S4).

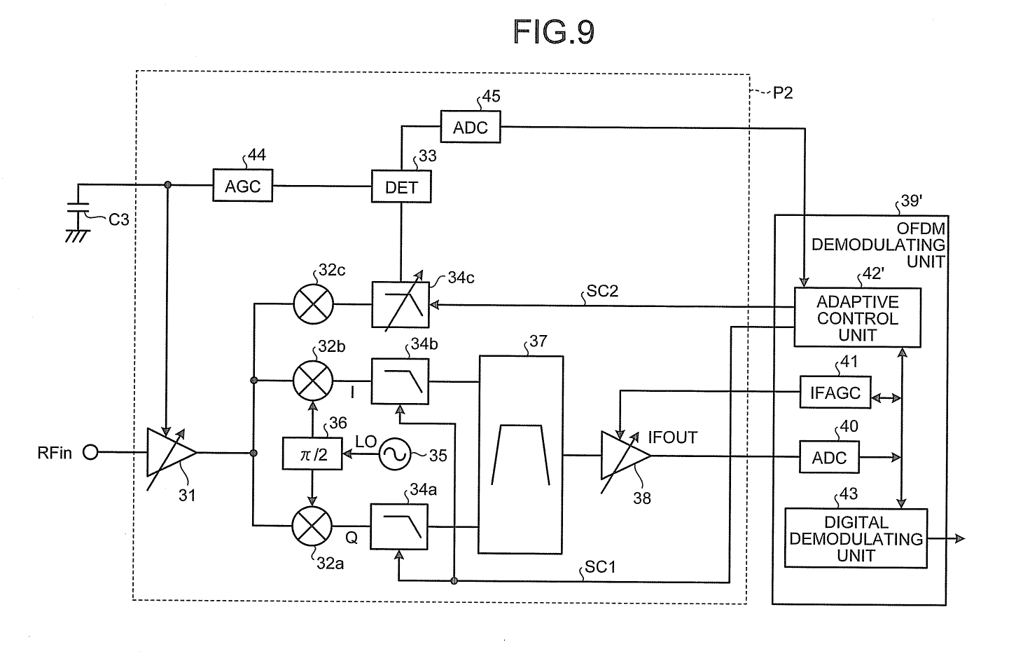

FIG. 8 is a diagram of an image of a MER value and a decision bit in the flowchart of FIG. 7.

In FIG. 8, because an MER and an SN ratio have a correlation, it is possible to determine good or bad of the reception state of the reception signal RFin by measuring the MER.

Consequently, even when a signal level and a detuning frequency of a disturbing wave included in the reception signal RFin change, it is possible to optimize the operating point of the variable gain amplifier 31. It is possible to reduce, while realizing low power consumption, the unnecessary components that depend on the sum of the noise figure (NF) of the receiving apparatus and the distortion caused by the disturbing wave.

Because the mixers 32a to 32c are separately provided on the output signal IFOUT side and the detector 33 side, even when a signal input to the detector 33 is controlled by the variable band low-pass filter 34c, it is possible to prevent the in-phase component I and the orthogonal component Q from being unbalanced.

In the third embodiment explained above, the method of measuring the MER to determine the reception state of the reception signal RFin is explained. However, as an index for determining the reception state of the reception signal RFin, a value other than the MER can be used.

FIG. 9 is a block diagram of a schematic configuration of a receiving apparatus according to a fourth embodiment of the present invention.

In FIG. 9, the receiving apparatus includes an OFDM demodulating unit 39′ instead of the OFDM demodulating unit 39 shown in FIG. 6 and additionally includes an A/D converter 45. The OFDM demodulating unit 39′ includes an adaptive control unit 42′ instead of the adaptive control unit 42 shown in FIG. 6. The adaptive control unit 42′ can generate, based on a detection level by the detector 33, the control signal SC1 for controlling characteristics of the low-pass filters 34a and 34b and the control signal SC2 for controlling a band of the variable band low-pass filter 34c. In general, because the capacitor C3 is large, the capacitor C3 is externally attached. However, the capacitor C3 can also be integrated on the semiconductor chip P2. The OFDM demodulating unit 39′ can be integrated on the semiconductor chip P2 or can be externally attached.

The detection level by the detector 33 is digitized by the A/D converter 45 and input to the adaptive control unit 42′. The control signals SC1 and SC2 are generated by the adaptive control unit 42′ based on the digitized detection level. The control signal SC1 is output to the low-pass filters 34a and 34b. The control signal SC2 is output to the variable band low-pass filter 34c. A pass band is set by the variable band low-pass filter 34c such that an operating point of the variable gain amplifier 31 is optimized. Consequently, a sum of unnecessary components included in outputs of the mixers 32a and 32b is minimized. The unnecessary components can include noise of the receiving apparatus itself, a secondary distortion of a disturbing wave, and a tertiary distortion of the disturbing wave.

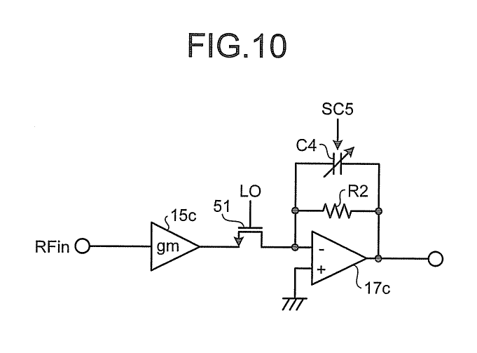

FIG. 10 is a block diagram of a schematic configuration of a receiving apparatus according to a fifth embodiment of the present invention.

In FIG. 10, the receiving apparatus includes a field effect transistor 51 as an example of the mixer 16c shown in FIG. 5. A variable capacitor C4 is connected in parallel to the resistor R2. A control signal SC5 for controlling a capacitance value of the variable capacitor C4 is input to the variable capacitor C4. The local oscillation signal LO is input to a gate of the field effect transistor 51. The reception signal RFin converted into an electric current by the voltage/current converter 15c is mixed with the local oscillation signal LO to be subjected to frequency conversion.

The capacitance value of the variable capacitor C4 is controlled based on a reception state of the reception signal RFin. Consequently, a band of the low-pass filter formed by the operational amplifier 17c is controlled and the operating point of the variable gain amplifier 14 shown in FIG. 5 is optimized.

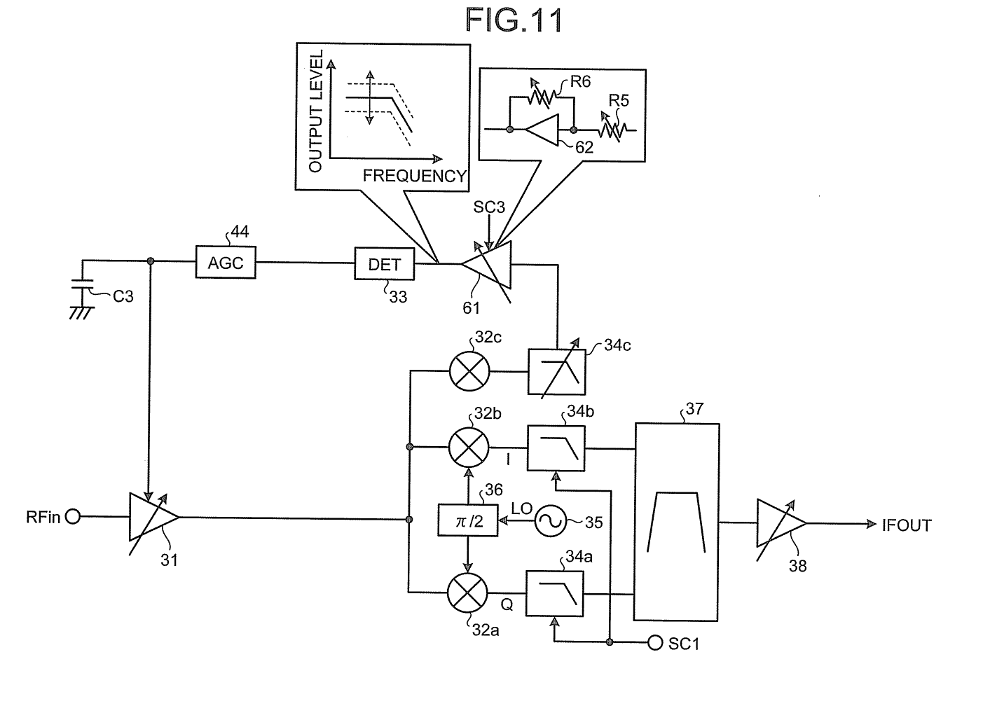

FIG. 11 is a block diagram of a schematic configuration of a receiving apparatus according to a sixth embodiment of the present invention.

In FIG. 11, the receiving apparatus includes a detection level adjusting amplifier 61 in addition to the components shown in FIG. 6. The detection level adjusting amplifier 61 is connected to an input side of the detector 33.

The detection level adjusting amplifier 61 can include an operational amplifier 62, a variable resistor R5 connected to an input side of the operational amplifier 62, and a variable resistor R6 connected between an input and an output of the operational amplifier 62.

A control signal SC3 for controlling an input level of the detector 33 is input to the detection level adjusting amplifier 61. The input level of the detector 33 is controlled based on a reception state of the reception signal RFin. Consequently, a detection level of the detector 33 is controlled and an operating point of the variable gain amplifier 31 is optimized.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A receiving apparatus comprising:
a variable gain amplifier that amplifies a reception signal;
a mixer that performs frequency conversion of the reception signal amplified by the variable gain amplifier;
a detector that detects the reception signal subjected to the frequency conversion;
an automatic gain control unit that controls, based on a detection level by the detector, a gain of the variable gain amplifier; and
an operating-point optimizing unit that optimizes an operating point of the variable gain amplifier by controlling, based on a reception state of the reception signal, an output signal from the mixer.

2. The receiving apparatus according to claim 1, wherein the operating-point optimizing unit optimizes the operating point of the variable gain amplifier by controlling a band of a disturbing wave component included in the reception signal.

3. The receiving apparatus according to claim 2, further comprising an operational amplifier that converts a current output from the mixer into a voltage output, wherein
the operating-point optimizing unit controls the band of the disturbing wave component included in the reception signal by controlling a bias current of the operational amplifier.

4. The receiving apparatus according to claim 1, wherein the operating-point optimizing unit optimizes the operating point of the variable gain amplifier by controlling a level of the output signal from the mixer.

5. The receiving apparatus according to claim 1, wherein the mixer for detection and the mixer for demodulation are separately provided.

6. The receiving apparatus according to claim 1, wherein the operating-point optimizing unit controls, based on an MER, the output signal from the mixer.

7. The receiving apparatus according to claim 1, wherein the operating-point optimizing unit controls, based on a detection level by the detector, the output signal from the mixer.

8. The receiving apparatus according to claim 1, wherein, the operating-point optimizing unit narrows an output band of the mixer when influence of far disturbance on a desired wave is strong compared with when the influence is weak.

9. The receiving apparatus according to claim 1, wherein the operating-point optimizing unit optimizes the operating point of the variable gain amplifier such that a sum of unnecessary components is minimized.

10. The receiving apparatus according to claim 9, wherein the unnecessary components include noise of the receiving apparatus itself, a secondary distortion of a disturbing wave, and a tertiary distortion of the disturbing wave.

11. A receiving apparatus comprising:
a variable gain amplifier that amplifies a reception signal;
a first mixer that performs frequency conversion of the reception signal amplified by the variable gain amplifier;
a second mixer that performs frequency conversion of the reception signal amplified by the variable gain amplifier;
a first low-pass filter that attenuates a high-frequency component of an output of the first mixer;
a second low-pass filer that attenuates a high-frequency component of an output of the second mixer;
a digital demodulating unit that performs, based on an output from the first low-pass filter, demodulation processing;
a detector that performs, based on an output from the second low-pass filter, detection of the reception signal;
an automatic gain control unit that controls, based on a detection level by the detector, a gain of the variable gain amplifier; and
an adaptive control unit that controls, based on the output from the first low-pass filter, a pass band of the second low-pass filter.

12. The receiving apparatus according to claim 11, wherein the adaptive control unit controls the pass band of the second low-pass filter such that an operating point of the variable gain amplifier is optimized.

13. The receiving apparatus according to claim 12, wherein the adaptive control unit optimizes the operating point of the variable gain amplifier such that a sum of unnecessary components included in the output of the first mixer is minimized.

14. The receiving apparatus according to claim 13, wherein the unnecessary components include noise of the receiving apparatus itself, a secondary distortion of a disturbing wave, and a tertiary distortion of the disturbing wave.

15. The receiving apparatus according to claim 11, wherein the adaptive control unit controls, based on an MER, the pass band of the second low-pass filter.

16. The receiving apparatus according to claim 15, wherein the adaptive control unit narrows the pass band of the second low-pass filter when the MER is good compared with when the MER is bad.

17. A receiving apparatus comprising:
a variable gain amplifier that amplifies a reception signal;
a first mixer that performs frequency conversion of the reception signal amplified by the variable gain amplifier;
a second mixer that performs frequency conversion of the reception signal amplified by the variable gain amplifier;
a first low-pass filter that attenuates a high-frequency component of an output of the first mixer;
a second low-pass filer that attenuates a high-frequency component of an output of the second mixer;
a digital demodulating unit that performs, based on an output from the first low-pass filter, demodulation processing;
a detector that performs, based on an output from the second low-pass filter, detection of the reception signal;
an automatic gain control unit that controls, based on a detection level by the detector, a gain of the variable gain amplifier; and
an adaptive control unit that controls, based on the detection level by the detector, a pass band of the second low-pass filter.

18. The receiving apparatus according to claim 17, wherein the adaptive control unit controls the pass band of the second low-pass filter such that an operating point of the variable gain amplifier is optimized.

19. The receiving apparatus according to claim 18, wherein the adaptive control unit optimizes the operating point of the variable gain amplifier such that a sum of unnecessary components included in the output of the first mixer is minimized.

20. The receiving apparatus according to claim 19, wherein the unnecessary components include noise of the receiving apparatus itself, a secondary distortion of a disturbing wave, and a tertiary distortion of the disturbing wave.
